(19) United States
(12) Patent Application Publication
(10) Pub. No.: US 2026/0235742 A1
(43) Pub. Date: Aug. 13, 2026

(54) Method for calibrating a LIDAR sensor

(71) Applicant: SICK AG, Waldkirch (DE)

(72) Inventors: Fabio ZACHERT, Stapelfeld (DE); Alexander VON BERGNER, Tremsbüttel (DE)

(21) Appl. No.: 19/535,278

(22) Filed: Feb. 10, 2026

(30) Foreign Application Priority Data
Feb. 13, 2025 (DE) 102025105323.5

(51) Int. Cl. G01S 7/497; B66C 15/00; B66C 19/00; G01S 17/88

(52) U.S. Cl. CPC G01S 7/497; B66C 15/00; G01S 17/88; B66C 19/002; B66C 19/007

(57) ABSTRACT

A method calibrates a LiDAR sensor arranged above a monitored zone at a carrier system and configured to detect objects within a plurality of mutually offset scanning planes. The method includes: providing a calibration body having a first edge and a second edge that converge at a corner point; arranging the calibration body such that the corner point is located at a reference position; determining the positions of the first edge and the positions of the second edge, both within at least two scanning planes; determining, based on the thus determined positions, the orientations of the first edge and the second edge; determining the point of intersection of the first edge and the second edge in a coordinate system that is stationary with respect to the carrier system; and determining, based on the determined point of intersection, the reference position in the coordinate system.

The invention relates to a method for calibrating a LiDAR sensor that is arranged above an elongate monitored zone at a carrier system and that is configured to detect objects within a plurality of mutually offset scanning planes by means of a time-of-flight method, wherein the scanning planes extend at least substantially parallel to a longitudinal center line of the monitored zone (center line in longitudinal direction of the elongate monitored zone).

LiDAR sensors (LiDAR for Light Detection And Ranging) are used in a variety of ways to handle security tasks. For example, container loading systems in container terminals must be reliably safeguarded. In such a container terminal, intermodal cranes are used to load containers onto and from transport vehicles. An intermodal crane is to be understood as a specific design of a crane that loads and unloads the different modes of transport in a multi-link transport chain or supply chain, for example, by maneuvering containers from one transport vehicle to another transport vehicle, for example from a truck to a container train. Such a container crane is moved by a crane control, wherein the picking up of the container and the movement of the container to its destination preferably take place in an automated manner, at least in a partly automated manner. A container crane can be configured as a rail-mounted gantry crane (RMG, Rail Mounted Gantry) or as a rubber-tired gantry crane (RTG, Rubber Tired Gantry).

For loading and unloading a transport vehicle, the container crane spans an area which is designed as a work surface and into which the transport vehicles drive along transport vehicle tracks in order to position themselves under the container crane region for loading and unloading. Access zones are formed between such loading zones so that in particular persons can assist the loading and unloading processes.

Since the movement of a container crane preferably takes place in an at least partly automated manner and a container crane operator only has a limited field of view due to the spatial extent of the work surface, it is necessary to monitor the loading processes using sensors. For example, to ensure that when the container is moved by the crane over the access zone, no persons are present in this region, in particular not in the region below the container.

The access zones can be monitored by means of at least one LiDAR sensor as described above, wherein they then form monitored zones. A LiDAR sensor can in particular be arranged centrally above each access zone, for example, at a carrier element that extends across the work surface. The sensor can in this respect be connected to a person recognition unit that identifies the work surface and the transport vehicles from the measurement point cloud. If there is a measurement point within the measurement point cloud that is more than 0.5 m above the identified work surface, a probable person signal is output by the person recognition unit so that a safety controller slows down or stops the crane movement.

A calibration of LiDAR sensors of the mentioned kind must in particular be carried out because as accurate as possible an assignment of the monitored zone to the measurement data of the sensor is of great importance for safety applications. In practice, for example, the scanning planes can—regardless of their substantially parallel alignment with the longitudinal center line—have a slight angular offset from the orientation of the monitored zone. It is also possible that the sensor is not positioned exactly at the center above the monitored zone. Such deviations should be compensated for by a calibration in order to ensure a reliable evaluation of the measurement data.

During the calibration, for example, the position of a floor marking relative to the crane can be manually measured and can be compared with the recognition in the measurement data. However, the provision of floor markings that can be easily detected by sensors is complex. Furthermore, the recognition is dependent on the sensor resolution. In particular, it is problematic that the spatial resolution of multi-layer LiDAR sensors is indeed relatively high within the scanning planes, but is fixedly predefined transversely to the longitudinal direction due to the mutual distance of the scanning planes and is generally relatively low. An increase in the number of scanning planes would involve disproportionately high costs.

It is an object of the invention to specify a calibration method that compensates for the deviations mentioned, that is quick and easy to perform and nevertheless has a high degree of precision.

The object is satisfied by a method having the features of claim 1.

A method according to the invention comprises the steps that:
(i) at least one calibration body is provided that has a first edge and a second edge that converge at a corner point,
(ii) the at least one calibration body is arranged in the monitored zone such that the corner point, viewed from above, is located at a reference position of the monitored zone,
(iii) by means of the LiDAR sensor, the positions of the first edge within at least two scanning planes are determined and the positions of the second edge within at least two scanning planes are determined,
(iv) based on the thus determined positions, the orientation of the first edge and the orientation of the second edge are determined,
(v) based on the orientation of the first edge and the orientation of the second edge, the point of intersection of the first edge and the second edge is determined in a coordinate system that is stationary with respect to the carrier system, and
(vi) based on the determined point of intersection, the reference position of the monitored zone is determined in the coordinate system that is stationary with respect to the carrier system.

Since the localization of the calibration body in the measurement data takes place based on the edge point of intersection, the calibration body does not need to be equipped with special recognition features. It is sufficient for the calibration body to have two edges converging at a corner. This is often the case with many known objects. Preferably, the calibration body is a portable object so that the positioning of the calibration body in the monitored zone can be manually performed in a simple manner. Due to the substantially straight-line behaviour of the edges, the position of the point of intersection can be determined relatively precisely by means of extrapolation, even if the point of intersection is located between two scanning planes and the distance between the scanning planes is relatively large. The low spatial resolution of the LiDAR sensor transverse to the scanning planes is therefore not a problem with a calibration method according to the invention. As soon as the point of intersection in the reference system of the LiDAR sensor is known, it can be equated with the reference position in the monitored zone, whereby a fixed relationship between the coordinate system of the LiDAR sensor and the world coordinate system is established.

One advantage of the method according to the invention is that the exact size of the calibration body does not have to be known. Time-consuming measurements of the calibration body are thus superfluous. A randomly available object can also be used as a calibration body.

In an advantageous embodiment of the method, the reference position is selected on the longitudinal center line that is particularly easy to locate or to measure. It is furthermore preferred if the first edge and the second edge of the calibration body converge at a right angle.

According to one embodiment of the invention, at least two calibration bodies are provided that have respective edges converging at a corner point, wherein the at least two calibration bodies are arranged in the monitored zone such that the corner points, viewed from above, are located at different reference positions of the monitored zone, and wherein the steps (iii) to (vi) are carried out for all the calibration bodies. By defining two different reference positions in the coordinate system of the LiDAR sensor, the position and the orientation of the monitored zone within the floor plane are completely and clearly defined from the point of view of the LiDAR sensor. The calibration can also be carried out using more than two calibration bodies in order, for example, to increase the accuracy by averaging.

A further embodiment of the invention provides that, based on the determined points of intersection, the position of a reference line of the monitored zone, preferably of the longitudinal center line of the monitored zone, is determined in the coordinate system that is stationary with respect to the carrier system. The center line of the monitored zone is relatively easy to find, even if no corresponding marking is present. For example, the center of the monitored zone can be determined by means of a measuring tape.

It is not absolutely necessary to determine a plurality of points of the reference line in the coordinate system of the carrier system. Rather, it is sufficient to determine a parallel shift and/or a tilt of the reference line with respect to a corresponding line of the sensor coordinate system.

Preferably, in step (ii), the at least one calibration body is arranged in the monitored zone such that the edges, viewed from above, extend obliquely to the longitudinal center line of the monitored zone. It is then ensured that both edges can be detected by a sufficient number of scanning planes.

Preferably, in step (i), at least one cuboid calibration body is provided. A cuboid calibration body is easy to obtain and to handle. For example, a packaging cardboard box can be used as a calibration body.

According to a further embodiment of the invention, in step (i), at least one calibration body is provided that has an L-shaped cross-section at least in one region, and the at least one calibration body is arranged in step (ii) such that the L shape is recognizable viewed from above. In this case, the two edges are formed by the front margins of the legs. L-shaped calibration bodies are particularly light and space-saving.

Preferably, in step (i), at least one calibration body is provided that has a length of at least 50 cm, a width of at least 50 cm and/or a height of at least 20 cm. The corresponding edge lengths are favorable for many applications to ensure a sufficient coverage of the edges by the scanning planes. A height of at least 20 cm is advantageous insofar as the placed calibration body is sufficiently raised from the floor in this embodiment in order to be reliably recognized by the LiDAR sensor.

The invention also relates to an apparatus for monitoring an elongate monitored zone, said apparatus comprising a carrier system and at least one LiDAR sensor that is arranged above the monitored zone at the carrier system and that is configured to detect objects within a plurality of mutually offset scanning planes by means of a time-of-flight method, wherein the scanning planes extend at least substantially parallel to a longitudinal center line of the monitored zone.

Irrespective of their basically substantially parallel alignment with the longitudinal center line and the basically central arrangement of the LiDAR sensor above the monitored zone, the scanning planes can have slight deviations from the predefined positioning. Such deviations should be compensated for in order to ensure a reliable evaluation of the measurement data. However, time-consuming measurement work and the provision of specific floor markings are undesirable.

According to the invention, the apparatus comprises an electronic control device that is in signal connection with the at least one LiDAR sensor and that is configured
to determine the orientations of two edges of a calibration body arranged in the monitored zone, said edges converging at a corner point, based on the positions of the edges within at least two scanning planes, said positions being determined by means of the LiDAR sensor,
based on the determined orientations, to determine the point of intersection of the edges in a coordinate system that is stationary with respect to the carrier system, and,
based on the determined point of intersection, to determine a reference position of the monitored zone in the coordinate system that is stationary with respect to the carrier system.

Since the localization of the calibration body in the measurement data takes place based on the edge point of intersection, the calibration body must not be equipped with special recognition features such as reflectors. Furthermore, the placement of the corner point on the reference position is possible in a fast and simple manner.

The carrier system can be the base frame of a gantry crane, in particular an intermodal crane.

The monitored zone can be a rectangular access strip between two loading zones. A rectangular shape of the monitored zone facilitates the evaluation of the sensor signals and avoids shadowing.

Depending on the application, the scanning planes can have a uniform or non-uniform angular offset from one another that is easy to realize. Due to a smaller angular offset of the scanning planes in selected regions, for example particularly critical regions, a higher calibration accuracy can, for example, be achieved in said regions.

Further developments of the invention can also be seen from the dependent claims, from the description and from the enclosed drawings.

the invention Will Be Described in the Following by Way of Example With Reference to the drawings.

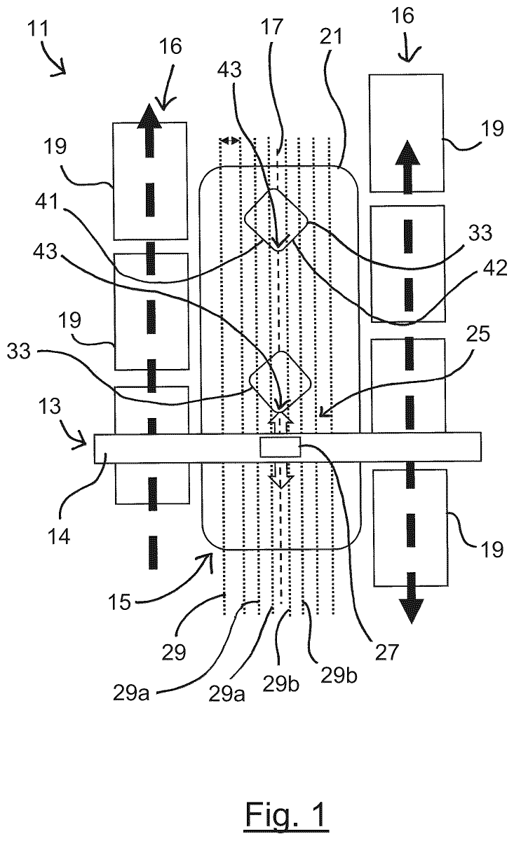

FIG. 1 shows a container loading system comprising an apparatus according to the invention for monitoring an elongate monitored zone of the container loading system, wherein two calibration bodies are arranged in the monitored zone;

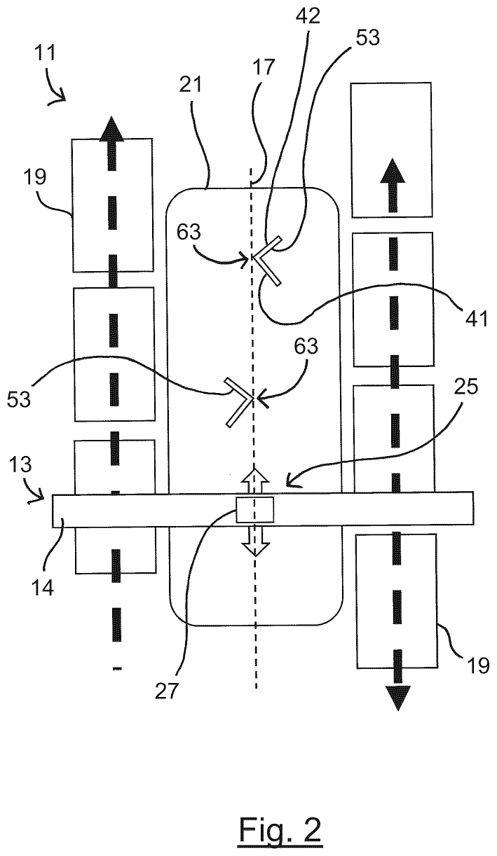

FIG. 2 shows the arrangement in accordance with FIG. 1 with alternatively designed calibration bodies; and

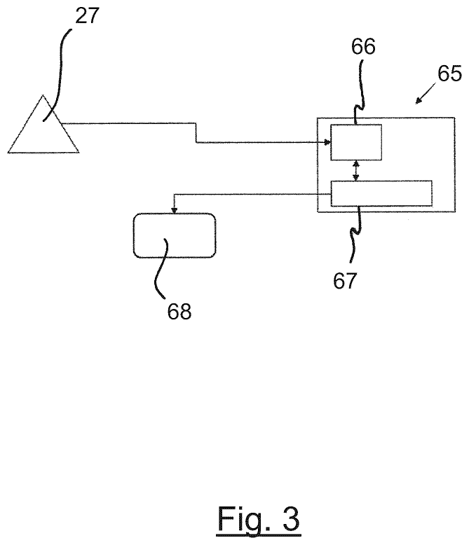

FIG. 3 schematically shows a control device for controlling the container loading system shown in FIG. 1.

The container loading system 11 shown in simplified form from above in FIG. 1 comprises a container crane 13 that has a carrier system 14 and that extends over a work surface 15. The work surface 15 comprises two elongate loading zones 16 that are arranged parallel to one another and that are separated by an access zone 21 that is likewise elongate and that extends parallel to the loading zones 16. Persons can check the adjacent loading zones 16 from the access zone 21. Transport vehicles for loading and unloading, which are not shown in FIG. 1, such as trucks, railroad cars or ships, are located on the loading zones 16. The access zone 21 has a longitudinal center line 17. The container crane 13 further has, in a manner known per se, a trolley not shown in FIG. 1 that is movably fastened to the carrier system 14 transversely to the longitudinal center line 17. A container 19 for loading and unloading transport vehicles can be fastened to the trolley using a lifting tool (not shown). For this purpose, the carrier system 14 can move parallel to the longitudinal center line 17.

The container loading system 11 comprises an apparatus 25 according to the invention for monitoring the access zone 21. In this regard, the access zone 21 represents a monitored zone.

The apparatus 25 for monitoring the access zone 21 has a LiDAR sensor 27 that is arranged above the access zone 21 at the carrier system 14, preferably centrally as shown. The LiDAR sensor 27 is oriented measuring downwardly and is configured to detect objects within a plurality of mutually offset scanning planes 29 by means of a time-of-flight method. This means that the LiDAR sensor 27 is a multi-layer sensor and is designed for a three-dimensional detection. The scanning planes 29, recognizable as lines in FIG. 1, are arranged in a fan shape and extend at least substantially parallel to the longitudinal center line 17.

It is understood that, in principle, a plurality of LiDAR sensors 27 can also be arranged at the carrier system 14.

The embodiment shown here of a method according to the invention for calibrating the LiDAR sensor 27 provides for two calibration bodies 33 to be placed in the access zone 21. The calibration bodies 33 can be portable cuboid objects such as packaging cardboard boxes. Each calibration body 33 is rectangular in the plan view and accordingly has a first edge 41 and a second edge 42 that converge at a corner point 43. The rectangular shape and the corner point are not to be understood in a strict mathematical sense. In particular, rounded corners can be present as shown. The calibration body 33 is in particular selected such that the first and the second edge are each so long that, with a corresponding arrangement of the calibration body 33, they are each detected by at least two scanning planes 29.

For the calibration process, the calibration bodies 33 are arranged at a distance from one another in the access zone 21 such that a respective corner point 43, viewed from above, is located on the longitudinal center line 17 of the access zone 21. If there is no marking, for example, the position of the longitudinal center line 17 can be measured with a measuring tape. Each calibration body 33 is oriented so that the first edge 41 and the second edge 42 extend obliquely to the longitudinal center line 17.

After the calibration bodies 33 have been positioned and oriented in this manner, the positions of the first edge 41 within those scanning planes 29 that extend through the first edge 41 are determined by means of the LiDAR sensor 27. In the embodiment example shown, they are two scanning planes 29a. The positions of the second edge 42 within two other scanning planes 29b are also determined.

Based on the thus determined positions, the straight-line orientations of the first edge 41 and the second edge 42 are determined. Based on the straight-line orientations, the point of intersection of the first edge 41 with the second edge 42 is determined in a coordinate system that is stationary with respect to the carrier system 14, i.e. in the reference system of the LiDAR sensor 27. Since each corresponding corner point 43, viewed from above, is located on the longitudinal center line 17, the point of intersection indicates the position of the longitudinal center line 17 in the reference system of the LiDAR sensor 27. Accordingly, for the calibration, the position of the longitudinal center line 17 in the coordinate system of the carrier system 14 is determined via the positions of the points of intersection. More than two calibration bodies 33 can also be used for an averaging. On the other hand, a single calibration body 33 may also be sufficient for a calibration if, for example, only the center of the access zone 21 is to be determined.

The calibration bodies 33 do not necessarily have to be cuboid. FIG. 2 shows, for example, the container loading system 11 using differently designed calibration bodies 53 that each have an L-shaped cross-section. Each of these calibration bodies 53 is arranged such that the L shape is recognizable viewed from above and the corner point 63 that is defined by the L tip lies on the longitudinal center line 17, viewed from above.

FIG. 3 schematically shows a control device 65 that is in signal connection with the LiDAR sensor 27 and that is provided for controlling the container loading system 11 shown in FIG. 1. The control device 65 has a reception unit 66 and a processing unit 67. When an object is recognized, the LiDAR sensor 27 sends a determination signal (not shown) to the reception unit 66 of the control device 65. The control unit 65 transmits the determination signal to the processing unit 67 for evaluation. The processing unit 67, for example, sends a stop signal to the container crane control 68. Alternatively thereto and/or in addition, a warning signal can be output to the container crane control 68. Further alternatively, the LiDAR sensor 27 can transmit a relative position of an object to the control device 65. The control device 65 evaluates the relative position of the object with respect to a predetermined minimum distance and, if the minimum distance is fallen below, a warning signal and/or a stop signal is/are output to the container crane control 68. It is ensured by the calibration that the access zone 21 to be monitored is correctly defined in the measurement point cloud of the LiDAR sensor 27.

The calibration method according to the invention can advantageously be used not only for the monitoring of container loading systems 11, but also for the monitoring of other devices such as automated production systems, storage systems or conveying systems.

### REFERENCE NUMERAL LIST

11 container loading system
13 container crane
14 carrier system
15 work surface
16 loading zone
17 longitudinal center line
19 container
21 access zone
25 monitoring device
27 LiDAR sensor
29 scanning plane
29a scanning plane extending through the first edge
29b scanning plane extending through the second edge
33 calibration body
41 first edge
42 second edge
43 corner point
53 calibration body
63 corner point
65 control device
66 reception unit
67 processing unit
68 container crane control

1. A method for calibrating a LiDAR sensor that is arranged above an elongate monitored zone at a carrier system and that is configured to detect objects within a plurality of mutually offset scanning planes by means of a time-of-flight method, wherein the scanning planes extend at least substantially parallel to a longitudinal center line of the monitored zone, wherein:
(i) at least one calibration body is provided that has a first edge and a second edge that converge at a corner point,
(ii) the at least one calibration body is arranged in the monitored zone such that the corner point, viewed from above, is located at a reference position of the monitored zone,
(iii) by means of the LiDAR sensor, the positions of the first edge within at least two scanning planes are determined and the positions of the second edge within at least two scanning planes are determined,
(iv) based on the thus determined positions, the orientation of the first edge and the orientation of the second edge are determined,
(v) based on the orientation of the first edge and the orientation of the second edge, the point of intersection of the first edge and the second edge is determined in a coordinate system that is stationary with respect to the carrier system, and
(vi) based on the determined point of intersection, the reference position of the monitored zone is determined in the coordinate system that is stationary with respect to the carrier system.

2. The method according to claim 1,
wherein at least two calibration bodies are provided that have respective edges converging at a corner point, wherein the at least two calibration bodies are arranged in the monitored zone such that the corner points, viewed from above, are located at different reference positions of the monitored zone, and wherein the steps to are carried out for all the calibration bodies.

3. The method according to claim 2,
wherein, based on the determined points of intersection, the position of a reference line of the monitored zone is determined in the coordinate system that is stationary with respect to the carrier system.

4. The method according to claim 3,
wherein a parallel displacement and/or a tilt of the reference line with respect to a coordinate axis of the coordinate system is determined.

5. The method according to claim 1,
wherein, in step, the at least one calibration body is arranged in the monitored zone such that the edges, viewed from above, extend obliquely to the longitudinal center line of the monitored zone.

6. The method according to claim 1,
wherein, in step, at least one cuboid calibration body is provided.

7. The method according to claim 1,
wherein, in step, at least one calibration body is provided that has an L-shaped cross-section at least in one region, wherein the at least one calibration body is arranged in step such that the L shape is recognizable viewed from above.

8. The method according to claim 1,
wherein, in step, at least one calibration body is provided that has a length of at least 50 cm, a width of at least 50 cm and/or a height of at least 20 cm.

9. An apparatus for monitoring an elongate monitored zone, said apparatus comprising a carrier system and at least one LiDAR sensor that is arranged above the monitored zone at the carrier system and that is configured to detect objects within a plurality of mutually offset scanning planes by means of a time-of-flight method, wherein the scanning planes extend at least substantially parallel to a longitudinal center line of the monitored zone, wherein the apparatus comprises an electronic control device that is in signal connection with the at least one LiDAR sensor and that is configured to determine the orientations of two edges of a calibration body arranged in the monitored zone, said edges converging at a corner point, based on the positions of the edges within at least two scanning planes, said positions being determined by means of the LiDAR sensor,
based on the determined orientations, to determine the point of intersection of the edges in a coordinate system that is stationary with respect to the carrier system, and,
based on the determined point of intersection, to determine a reference position of the monitored zone in the coordinate system that is stationary with respect to the carrier system.

10. The apparatus according to claim 9,
wherein the carrier system is the base frame of a gantry crane.

11. The apparatus according to claim 10,
wherein the monitored zone is a rectangular access strip between two loading zones.

12. The apparatus according to claim 9,
wherein the scanning planes have a uniform or non-uniform angular offset from one another.

13. The method according to claim 3,
wherein the reference line of the monitored zone is the longitudinal center line of the monitored zone.

14. The apparatus according to claim 10,
wherein the gantry crane is an intermodal crane.
